(19) United States
(12) Patent Application Publication
(10) Pub. No.: US 2006/0102877 A1
(43) Pub. Date: May 18, 2006

(54) System and method for manufacturing a liquid crystal display device

(76) Inventors: Jin-Sung Kim, Asan-si (KR); Youn-Ho Lee, Cheonan-si (KR); Min-Young Won, Yongin-si (KR); Hyun-Su Lee, Asan-si (KR)

Correspondence Address: CANTOR COLBURN, LLP, 55 GRIFFIN ROAD SOUTH, BLOOMFIELD, CT, 06002, US

(21) Appl. No.: 11/219,941

(22) Filed: Sep. 6, 2005

(30) Foreign Application Priority Data
Nov. 3, 2004 (KR) 10-2004-0089000
Dec. 21, 2004 (KR) 10-2004-0109639

(51) Int. Cl. C09K 19/52

(52) U.S. Cl. 252/299.01

(57) ABSTRACT

A system for manufacturing a liquid crystal display device includes a vessel storing liquid crystal (LC), a nozzle for dropping the LC onto a liquid crystal display panel, a pressurizer configured to draw a predetermined amount of the LC from the vessel and discharge the drawn LC into the nozzle, and a valve alternately communicating the pressurizer with the vessel or with the nozzle.

This application claims the priority of Korean Patent Application Nos. 10-2004-0089000 filed on Nov. 3, 2004 and 10-2004-0109639 filed on Dec. 21, 2004, in the Korean Intellectual Property Office, the disclosure of which is incorporated herein in its entirety by reference.

### BACKGROUND OF THE INVENTION

(a) Field of the Invention

The present invention relates to a system and method for manufacturing a liquid crystal display device, and in particular, to an apparatus and method for dropping a liquid crystal (LC) on a display panel.

(b) Description of Related Art

Generally, a liquid crystal display device includes an upper display panel and a lower display panel that each include field generating electrodes, and a liquid crystal layer disposed between the upper and lower display panels. Liquid crystal molecules of the liquid crystal layer are rearranged by voltages supplied to the field generating electrodes. A transmittance of light passing through the liquid crystal layer is varied in response to an arrangement of the liquid crystal molecules. Thus, images are displayed on the liquid crystal display device by controlling the transmittance of light passing through the liquid crystal layer via the voltages supplied to the field generating electrodes

Such a liquid crystal display device is manufactured by a process described below. First, an alignment layer for aligning liquid crystal molecules is coated on the lower display panel. Second, an active area is defined in a closed-loop shape on the lower display panel by applying a sealant. Third, a liquid crystal (LC) is dropped on the active area. Fourth, the upper and lower display panels are assembled in a vacuum state, and the sealant is hardened.

A conventional apparatus for dropping the LC used for manufacturing a liquid crystal display device will hereinafter be described in detail.

A conventional apparatus for dropping LC includes a bottle filled with LC, a syringe directly dropping the LC on the lower display panel, and a needle opening/closing a nozzle formed at the syringe.

However, according to such a conventional system for manufacturing a liquid crystal display device, LC in the syringe flows onto the lower display panel by gravity, without a separate pressure tool. Accordingly, dropping speed is slow, and an amount of dropped LC is not precisely controlled.

### SUMMARY OF THE INVENTION

The present invention has been made in an effort to provide a system for manufacturing flat panel display devices having an advantage of a higher dropping speed of liquid crystal (LC) and a precise control of a dropping amount of the LC.

An exemplary system for manufacturing a liquid crystal display device according to an exemplary embodiment of the present invention includes a vessel storing LC, a nozzle for dropping the LC on a liquid crystal display panel, a pressurizer configured to draw a predetermined amount of the LC from the vessel and discharge the drawn LC into the nozzle, and a valve alternately communicating between the pressurizer and one of the vessel and the nozzle.

Another exemplary system for manufacturing a liquid crystal display device according to an exemplary embodiment of the present invention includes a vessel storing LC, a nozzle for dropping the LC on a liquid crystal display panel, and a pump. The pump is configured to draw a predetermined amount of the LC from the vessel and discharge the drawn LC into the nozzle. The pump includes a pressurizer, a valve, and a valve driver. The pressurizer draws and discharges the LC. The valve alternately communicates the pressurizer with one of the vessel and the nozzle. The valve driver operates cooperatively with the pressurizer to drive the valve.

An exemplary method for manufacturing a liquid crystal display device according to an embodiment of the present invention includes providing a liquid crystal display panel, charging a predetermined amount of LC from a vessel into a cylinder provided to a pressurizer by an operation of the pressurizer, storing the charged LC in the cylinder; discharging the stored LC into a nozzle, and dropping the discharged LC on the liquid crystal display panel.

### BRIEF DESCRIPTION OF THE DRAWINGS

The present invention will become more apparent by describing exemplary embodiments thereof in detail with reference to the accompanying drawings, in which:

FIG. 1 is a schematic view of a system for manufacturing a liquid crystal display device according to an exemplary embodiment of the present invention;

FIG. 2 is a sectional view taken along line II-II in FIG. 1;

FIG. 3 shows a charge state of the system for manufacturing a liquid crystal display device shown in FIG. 1 in which liquid crystal is drawn into a cylinder;

FIG. 4 shows a discharge state of the system for manufacturing a liquid crystal display device shown in FIG. 1 in which liquid crystal is discharged from the cylinder; and

FIG. 5 is a flowchart showing a method for manufacturing a liquid crystal display device according to an exemplary embodiment of the present invention.

### DETAILED DESCRIPTION OF THE INVENTION

The present invention now will be described with reference to the accompanying drawings, in which exemplary embodiments of the invention are shown. This invention may, however, be embodied in many different forms and should not be construed as limited to the embodiments set forth herein.

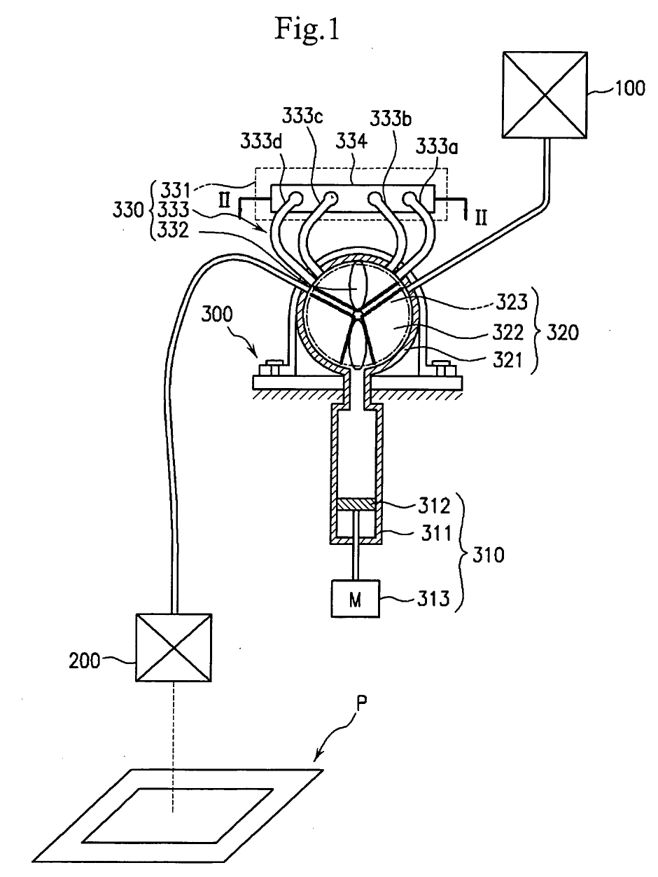

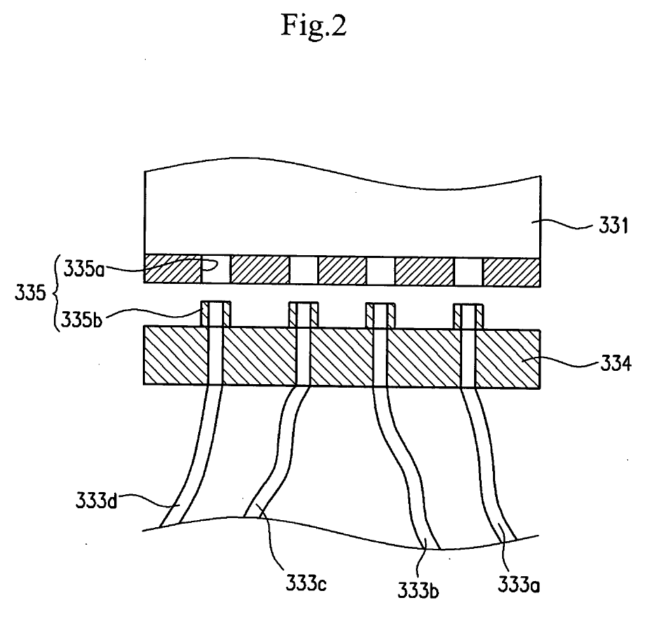

FIG. 1 is a schematic view of a system for manufacturing a liquid crystal display device according to an exemplary embodiment of the present invention; and FIG. 2 is a sectional view taken along line II-II in FIG. 1.

As shown in FIG. 1, a system for manufacturing a liquid crystal display according to an exemplary embodiment of the present invention includes a liquid crystal (LC) vessel 100, an LC nozzle 200, and an LC pump 300.

The LC vessel 100 stores LC, and is usually supplied from a manufacturer in a state filled with the LC. The LC nozzle 200 drops the LC on a liquid crystal display panel P. The LC pump 300 is provided between the LC vessel 100 and the LC nozzle 200, and draws a predetermined amount of LC from the LC vessel 100 and discharges it through the LC nozzle 200. An exemplary LC pump 300 includes an LC pressurizer 310 and a valve 320.

The LC pressurizer 310 draws or discharges the LC in response to an operational state of the system. The LC pressurizer 310 further includes a cylinder 311 for temporarily storing drawn LC, a piston 312 slidably disposed in the cylinder 311, and a step motor 313 precisely controlling a reciprocating motion of the piston 312. The valve 320 enables the cylinder 311 to communicate with the LC vessel 100, or with the LC nozzle 200, depending on the operational state of the system.

Particularly, the valve 320 includes a case 321 with a circular cross-section, a valve body 322 rotating around a center of the case 321, and passages 323 radially extending inward to a center of the valve body 322. In an exemplary embodiment, a number of the passages 323 is three and each of the passages 323 is disposed adjacent to each other and spans about a 120° arc of space within the valve body 322.

The LC pump 300 further includes a valve driver 330, which operates cooperatively with the LC pressurizer 310 and drives the valve 320. The valve driver 330 includes a hydraulic source 331, an actuator 332, and hydraulic lines 333. The actuator 332 is coupled to the valve body 322, and rotates around a center of the valve body 322 in response to hydraulic pressure supplied from the hydraulic source 331 thereby driving the valve body 322. It is preferable that the actuator 332 is formed to have an airfoil shape.

The hydraulic lines 333 guide hydraulic pressure from the hydraulic source 331 into the actuator 332 or guide hydraulic pressure from the actuator 332 into the hydraulic source 331. The hydraulic lines 333 include first, second, third, and fourth hydraulic lines 333a, 333b, 333c, and 333d. The first and third hydraulic lines 333a and 333c guide hydraulic pressure from the hydraulic source 331 into the actuator 332, and the second and fourth hydraulic lines 333b and 333d guide hydraulic pressure from the case 321 into the hydraulic source 331. Accordingly, if the above-mentioned LC pump 300 is provided, an amount of LC dropped on the liquid crystal display panel P is precisely controlled and a dropping speed may be increased.

The first, second, third, and fourth hydraulic lines 333a, 333b, 333c, and 333d are mounted to a head 334 to enable simultaneous coupling of the hydraulic lines 333 to the hydraulic source 331. Thus, when the LC is changed a changing time can be reduced, and consequently an operation rate of the system is improved. The LC must be changed because different kinds of LC are used according to modes such as a vertical alignment mode and a horizontal alignment mode. Changing the LC requires changing of all components used for a previous LC.

In order to reduce the changing time of the LC, the above-mentioned system for manufacturing a liquid crystal display according to an exemplary embodiment of the present invention is believed to be preferable.

Furthermore, as shown in FIG. 2, it is preferable that the head 334 and the hydraulic source 331 are removably coupled by a coupling unit 335. The coupling unit 335 includes insertion holes 335a disposed at the hydraulic source 331 and projection pipes 335b disposed at the head 334. A number of the insertion holes 335a is equal to a number of hydraulic lines 333, and a number of the projection pipes 335b disposed at the head 334 is equal to the number of the insertion holes 335a. The projection pipes 335b communicate with the hydraulic lines 333. In order to simultaneously couple the hydraulic source 331 to the hydraulic lines 333, the head 334 is placed proximate to the hydraulic source 331 such that the projection pipes 335b are mated with corresponding insertion holes 335a.

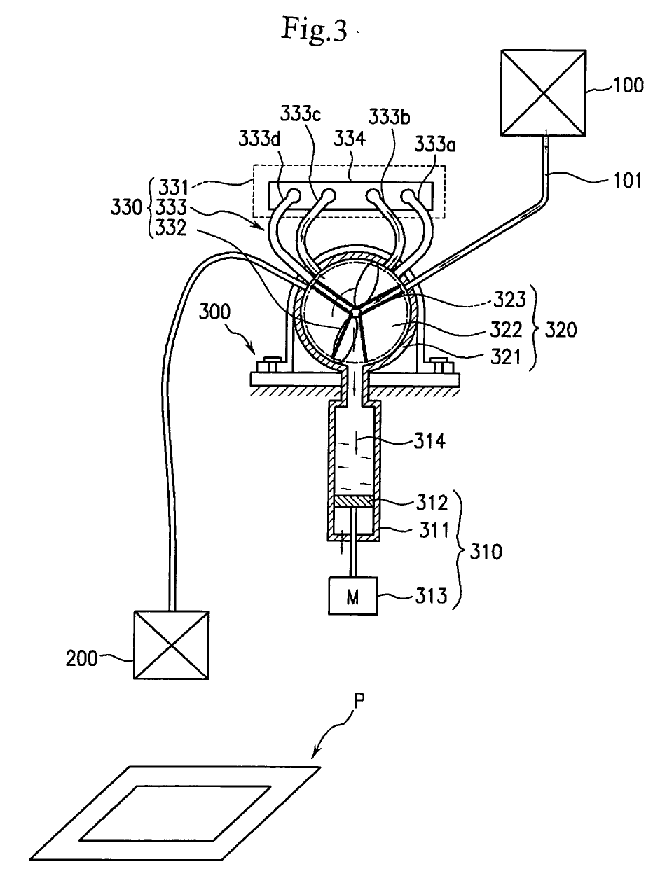

A method for manufacturing a liquid crystal display device according to an exemplary embodiment of the present invention will hereinafter be described in detail with reference to FIGS. 3 to 5.

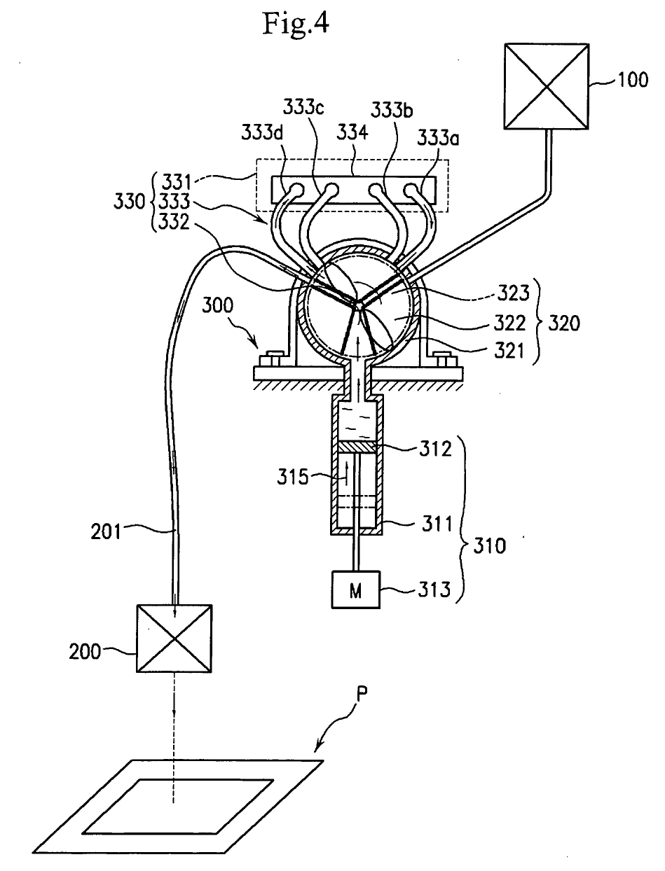

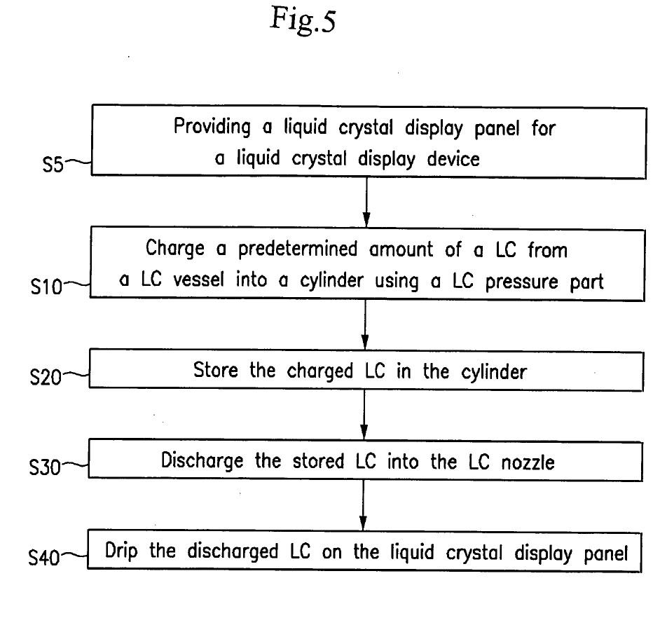

FIG. 3 shows a charge state of the system for manufacturing a liquid crystal display device shown in FIG. 1 in which liquid crystal is drawn into the cylinder 311. FIG. 4 shows a discharge state of the system for manufacturing a liquid crystal display shown in FIG. 1 in which liquid crystal is discharged from the cylinder 311. FIG. 5 is a flowchart showing a method for manufacturing a liquid crystal display according to an exemplary embodiment of the present invention. The charge and discharge states are each examples of operational states of the system for manufacturing a liquid crystal display device.

The method for manufacturing a liquid crystal display device according to this embodiment includes providing a liquid crystal display panel for a liquid crystal display device at block S5 in FIG. 5. During the charge state, at block S10, a predetermined amount of LC is charged from the LC vessel 100 into the cylinder 311 by the LC pressurizer 310 by drawing LC into the cylinder 311. At block S20, the LC charged into the cylinder 311 is temporarily stored in the cylinder 311. During the discharge state, at block S30, the LC being stored in the cylinder 311 is discharged to the LC nozzle 200. At block S40, the LC discharged to the LC nozzle 200 is dropped onto the liquid crystal display panel P. In addition, it is preferable that bubbles contained in the LC are removed before the predetermined amount of LC is charged from the LC vessel 100 into the cylinder 311.

The predetermined amount of LC drawn into the cylinder 311 is precisely controlled by the step motor 313 provided to the LC pressurizer 310. It is preferable that the predetermined amount of LC is about 2 cc to about 3 cc of LC, which is about 1 mg to about 3 mg in weight.

In addition, the method for manufacturing a liquid crystal display device according to an exemplary embodiment of the present invention further includes communicating the LC vessel 100 with the cylinder 311 or with the LC nozzle 200, depending on the operational state. The communicating of the LC vessel 100 will hereinafter be described in detail with reference to FIGS. 3 and 4.

First, as shown in FIG. 3, a hydraulic pressure from the hydraulic source 331 is supplied to the case 321 through the third hydraulic line 333c and discharged from the case 321 to the hydraulic source 331 through the second hydraulic line 333b causing the actuator 332 to rotate clockwise. In response to a rotation of the actuator 332, the valve body 322, which is coupled to the actuator 332, rotates. Rotation of the valve body 332 enables communication between each of the passages 323 with a first pipe 101, sequentially. After the passages 323 of the valve body 322 sequentially communicate with the first pipe 101 of the LC vessel 100 and with the cylinder 311, supply of the hydraulic pressure from the hydraulic source 331 is stopped. Thereafter, in response to the piston 312 being drawn in a direction indicated by arrow 314 by the step motor 313, the LC in the LC vessel 100 is drawn into the cylinder 311 through the passages 323, thereby charging the cylinder 311.

Second, as shown in FIG. 4, hydraulic pressure of the hydraulic source 331 is supplied to the case 321 through the first hydraulic line 333a and discharged from the case 321 into the hydraulic source 331 through the fourth hydraulic line 333d causing the actuator 332 to counterclockwise. In response to a rotation of the actuator 332, the valve body 322, which is coupled to the actuator 332, rotates. Rotation of the valve body 332 enables communication between each of the passages 323 with a second pipe 201, sequentially. After the passages 323 of the valve body 322 sequentially communicate with the second pipe 201 of the LC nozzle 200 and with the cylinder 311, a supply of the hydraulic pressure from the hydraulic source 331 is stopped. Thereafter, in response to the piston 312 being pushed in a direction indicated by arrow 315 by the step motor 313, the LC in the cylinder 311 is discharged into the LC nozzle 200 through the passages 323. The LC is thereafter dropped on the liquid crystal display panel P of the liquid crystal display device.

In addition, when the LC is changed, as shown in FIG. 2, the head 334 is moved such that the projection pipes 335b are separated from the insertion holes 335a, and then projection pipes of a head of a new system are simultaneously inserted in the insertion holes 335a of the pressure source 331.

As has been explained, a system and method for manufacturing a liquid crystal display according to an exemplary embodiment of the present invention has the following advantages. An amount of the LC that is being dropped on a liquid crystal display panel may be precisely controlled, and a dropping speed is increased by an LC pressurizer which is provided. In addition, since a coupling unit is provided, the changing time of the LC is reduced. Consequently, an operation rate of the system can be significantly improved.

While the present invention has been described in detail with reference to exemplary embodiments, it should be understood that the invention is not limited to the disclosed embodiments, but, on the contrary, is intended to cover various modifications and equivalent arrangements included within the sprit and scope of the appended claims.

What is claimed is:

1. A system for manufacturing a liquid crystal display device, comprising:
a vessel storing liquid crystal;
a nozzle for dropping the liquid crystal on a liquid crystal display panel;
a pressurizer configured to draw a predetermined amount of the liquid crystal from the vessel and discharge drawn liquid crystal into the nozzle; and
a valve alternately communicating between the pressurizer and one of the vessel and the nozzle.

2. The system of claim 1, wherein the liquid crystal pressurizer comprises:
a cylinder temporarily storing the drawn liquid crystal;
a piston slidably disposed in the cylinder; and
a step motor in operable communication with the piston to control a reciprocating motion of the piston.

3. The system of claim 1, wherein the valve comprises:
a case of a substantially circular shape;
a valve body configured to rotate around a center of the case; and
a passage disposed at the valve body.

4. The system of claim 3, wherein the valve body includes three passages and each of the three passages is disposed adjacent to each other such that each of the three passages spans about a 120° arc of space within the valve body.

5. The system of claim 3, further comprising a valve driver driving the valve, the valve driver operating cooperatively with the pressurizer.

6. The system of claim 5, wherein the valve driver comprises:
a hydraulic source;
an actuator in mechanical communication with the valve body, the actuator driving the valve body in response to hydraulic pressure supplied by the hydraulic source; and
hydraulic lines providing the hydraulic pressure from the hydraulic source to the actuator and returning the hydraulic pressure from the actuator to the hydraulic source.

7. The system of claim 6, wherein the hydraulic lines are mounted to a head to enable the hydraulic lines to be coupled to the hydraulic source simultaneously.

8. The system of claim 7, wherein the head and the hydraulic source are removably coupled to each other by a coupling unit.

9. The system of claim 8, wherein the coupling unit comprises:
insertion holes disposed at the hydraulic source, a number of the insertion holes being equal to a number of hydraulic lines; and
projection pipes disposed at the head, a number of the projection pipes being equal to the number of the insertion holes, the projection pipes communicating with the hydraulic lines.

10. A system for manufacturing a liquid crystal display device, comprising:
a vessel storing liquid crystal;
a nozzle for dropping the liquid crystal on a liquid crystal display panel; and
a pump disposed between the vessel and the nozzle, the pump configured to draw a predetermined amount of the liquid crystal from the vessel and discharge the drawn liquid crystal into the nozzle,
wherein the pump comprises:
a pressurizer for drawing and discharging the liquid crystal;
a valve alternately communicating the pressurizer with one of the vessel and the nozzle; and
a valve driver operating cooperatively with the pressurizer to drive the valve.

11. A method for manufacturing a liquid crystal display device, comprising:
providing a liquid crystal display panel;
charging a predetermined amount of liquid crystal from a vessel into a cylinder provided to a pressurizer by an operation of the pressurizer;
storing the charged liquid crystal in the cylinder;
discharging the stored liquid crystal into a nozzle; and
dropping the discharged liquid crystal on the liquid crystal display panel.

12. The method of claim 11, further comprising removing bubbles contained in the liquid crystal before charging the predetermined amount of liquid crystal from the vessel into the cylinder.

13. The method of claim 11, wherein the charging the predetermined amount of liquid crystal is controlled by a step motor provided to the pressurizer.

14. The method of claim 11, wherein the predetermined amount of liquid crystal is about 2 cc to about 3 cc.

15. The method of claim 11, further comprising alternately communicating the cylinder with one of the vessel and the nozzle.

16. The method of claim 15, wherein the communicating the cylinder with the vessel comprises:
rotating a valve via a valve driver;
stopping the valve driver in response to a passage of the valve providing communication between the vessel and the cylinder;

17. The method of claim 15, wherein the communicating the cylinder with the nozzle comprises:
rotating a valve via a valve driver; and
stopping the valve driver in response to a passage of the valve providing communication between the cylinder and the nozzle.

18. The method of claim 16, wherein the valve driver comprises:
a hydraulic source;
an actuator in mechanical communication with a valve body of the valve, the actuator driving the valve body in response to hydraulic pressure supplied by the hydraulic source; and
hydraulic lines providing the hydraulic pressure from the hydraulic source to the actuator and returning the hydraulic pressure from the actuator to the hydraulic source,
wherein when the liquid crystal is changed, the hydraulic lines are simultaneously removed from the hydraulic source via a head.

19. The method of claim 17, wherein the valve driver comprises:
a hydraulic source;
an actuator in mechanical communication with a valve body of the valve, the actuator driving the valve body in response to hydraulic pressure supplied by the hydraulic source; and
hydraulic lines providing the hydraulic pressure from the hydraulic source to the actuator and returning the hydraulic pressure from the actuator to the hydraulic source,
wherein when the liquid crystal is changed, the hydraulic lines are simultaneously removed from the hydraulic source via a head.
